(19) United States
(12) Patent Application Publication
(10) Pub. No.: US 2021/0039829 A1
(43) Pub. Date: Feb. 11, 2021

(54) TAB, CAN LID, AND METHOD FOR MANUFACTURING CAN LID

(71) Applicant: DAIWA CAN COMPANY, Tokyo (JP)

(72) Inventors: Toshiyuki Ohkoshi, Tokyo (JP); Masahiko Yasaka, Tokyo (JP); Shinji Shimazu, Tokyo (JP); Tadayosi Iwamaru, Mohka-shi (JP); Hirohumi Fujiwara, Kitakyushu-shi (JP)

(73) Assignee: DAIWA CAN COMPANY, Tokyo (JP)

(21) Appl. No.: 17/079,133

(22) Filed: Oct. 23, 2020

Related U.S. Application Data
(63) Continuation of application No. PCT/JP2019/016014, filed on Apr. 12, 2019.

(30) Foreign Application Priority Data
Apr. 27, 2018 (JP) 2018-087316

(51) Int. Cl. B65D 17/28; B41M 1/10; B41M 1/28; B21D 51/38

(52) U.S. Cl. CPC B65D 17/4012; B41M 1/10; B65D 2517/5075; B21D 51/383; B65D 2517/0016; B41M 1/28

(57) ABSTRACT

A tab formed of a metal plate in which a resin film is laminated on at least one main surface of a base member made of a metal material, includes: a fixing portion including a rivet hole into which a rivet formed on a panel portion of a can lid is inserted; a pressing portion formed integrally with the fixing portion and configured to press a portion in a region defined by a score line formed on the panel portion; and a finger hook portion formed integrally with the pressing portion.

### CROSS-REFERENCE TO RELATED APPLICATIONS

This is a Continuation Application of PCT application No. PCT/JP2019/016014, filed Apr. 12, 2019, which was published under PCT Article 21(2) in Japanese.

This application is based upon and claims the benefit of priority from Japanese Patent Application No. 2018-087316, filed Apr. 27, 2018, the entire contents of which are incorporated herein by reference.

### BACKGROUND

### Field

The present invention relates generally to a tab used for a can container, a can lid, and a method for manufacturing the can lid.

### Description of the Related Art

As can lids of can containers for beverages, food products, and the like, stay-on-tab type can lids, in which a lid opening operation is performed using a tab, are conventionally used. Such can lids have a configuration in which a finger hook portion of a tab fixed to a panel portion with a rivet is lifted to generate leverage, and a part of the panel portion is broken along a score line by the leverage so that the panel portion is opened.

In such can lids, a cylindrical rivet formed on the panel portion is inserted into a rivet hole formed in the tab, and the upper end of the rivet is swaged, so that the tab is fixed to the panel portion. Thus, the tab is fixed to the panel portion rotatably about the rivet in a circumferential direction.

However, if the tab rotates in the circumferential direction and the center of the tab is located at a position shifted from the line passing through the rivet and a predetermined position inside the score line, easy lid openability may be decreased because the force of leverage does not sufficiently act on the score line at the time of the lid opening operation. For this reason, a technique for preventing rotation of a tab in a circumferential direction is known, as disclosed in Jpn. Pat. Appln. KOKAI Publication No. H8-53131.

### BRIEF SUMMARY OF THE INVENTION

However, the above-mentioned technique requires special forming of a tab and a can lid body. This may cause a difficulty in forming or an increase in manufacturing costs.

Thus, the present invention aims at providing a tab, a can lid, and a method of manufacturing the can lid that make it possible to prevent the tab from rotating in a circumferential direction with a simple configuration.

According to one aspect of the present invention, a tab is formed of a metal plate in which a resin film is laminated on at least one main surface of a base member made of a metal material, and comprises: a fixing portion including a rivet hole into which a rivet formed on a panel portion of a can lid is inserted; a pressing portion formed integrally with the fixing portion and configured to press a portion in a region defined by a score line formed in the panel portion; and a finger hook portion formed integrally with the pressing portion.

According to one aspect of the present invention, a can lid comprises: a panel portion including a rivet and a score line which is provided adjacent to the rivet and which defines an opening piece when broken by application of an external force; and a tab which is formed of a metal plate in which a resin film is laminated on at least one main surface of a base member made of a metal material, and which includes a fixing portion including a rivet hole into which the rivet is inserted, a pressing portion formed integrally with the fixing portion and configured to press a portion in a region defined by the score line formed in the panel portion, and a finger hook portion formed integrally with the pressing portion.

According to one aspect of the present invention, a method for manufacturing a can lid comprises: forming a metal plate by bonding a film layer to at least one main surface of a thin plate-shaped base member made of a metal material; forming a tab, which includes a fixing portion including a rivet hole into which a rivet formed on a panel portion of a can lid is inserted, a pressing portion formed integrally with the fixing portion and configured to press a portion in a region defined by a score line formed in the panel portion, and a finger hook portion formed integrally with the pressing portion, from the metal plate such that, when the tab is fixed to the panel portion, a main surface of the metal plate in which the film layer is provided becomes an external main surface of the tab; arranging the formed tab on the panel portion; and swaging the rivet inserted into the rivet hole.

### BRIEF DESCRIPTION OF THE DRAWINGS

FIG. 1 is a plan view showing a configuration of a can lid according to one embodiment of the present invention.

FIG. 2 is a cross-sectional view showing a configuration of the can lid.

FIG. 3 is a plan view showing a configuration of a tab used for the can lid.

FIG. 4 is a plan view showing a configuration of the tab.

FIG. 5 is a cross-sectional view showing a partial configuration of the tab.

FIG. 6 is an explanatory view showing an example of a method for manufacturing the can lid.

FIG. 7 is an explanatory view showing an example of the method for manufacturing the can lid.

FIG. 8 is an explanatory view showing an example of the method for manufacturing the can lid.

FIG. 9 is a flowchart showing an example of the method for manufacturing the can lid.

FIG. 10 is a plan view showing a modification of a printing layer of the tab.

FIG. 11 is a plan view showing a modification of the printing layer of the tab.

FIG. 12 is a cross-sectional view showing a modification of a partial configuration of the tab.

FIG. 13 is a cross-sectional view showing a modification of a partial configuration of the tab.

FIG. 14 is a cross-sectional view showing a modification of a partial configuration of the tab.

### DETAILED DESCRIPTION

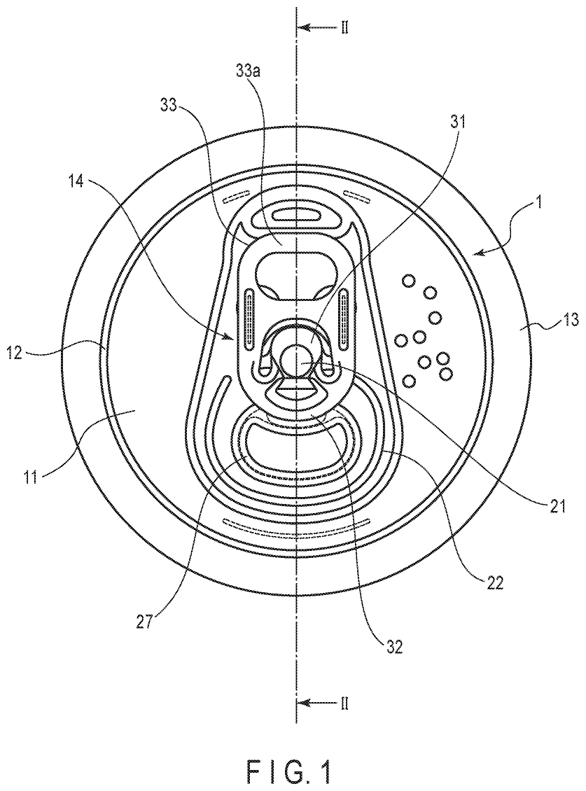

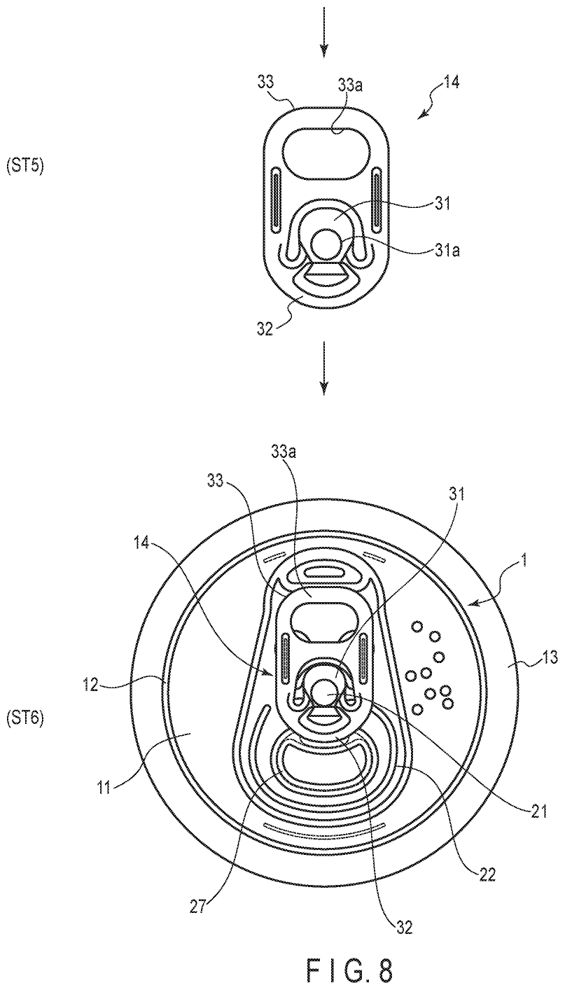

Hereinafter, a configuration of a can lid 1 including a tab 14 and a method for manufacturing the can lid 1 according to an embodiment of the present invention will be described with reference to FIGS. 1 to 9.

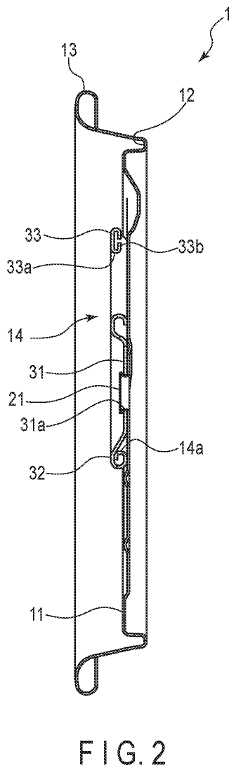

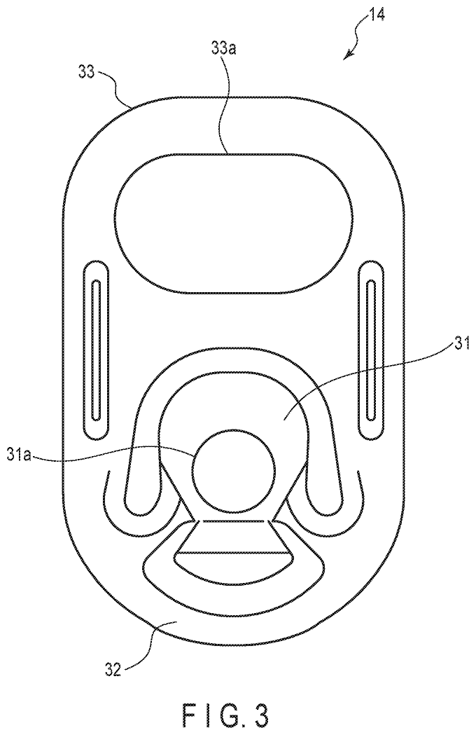

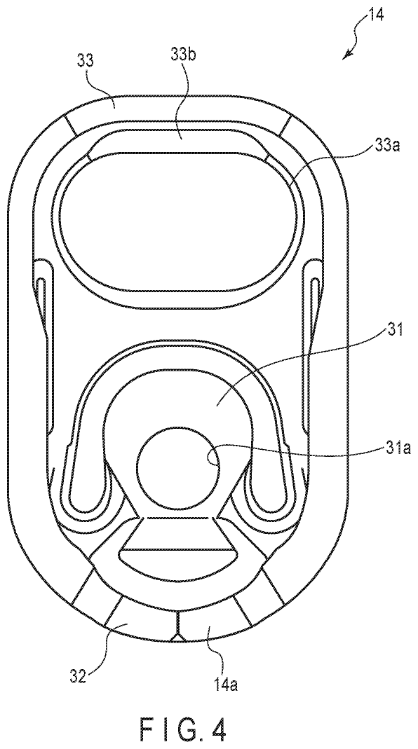

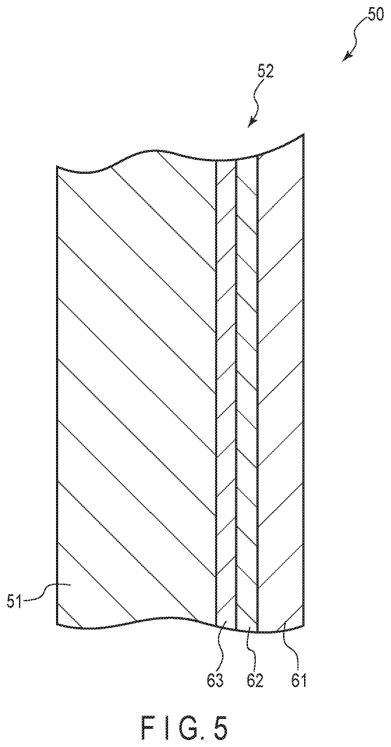

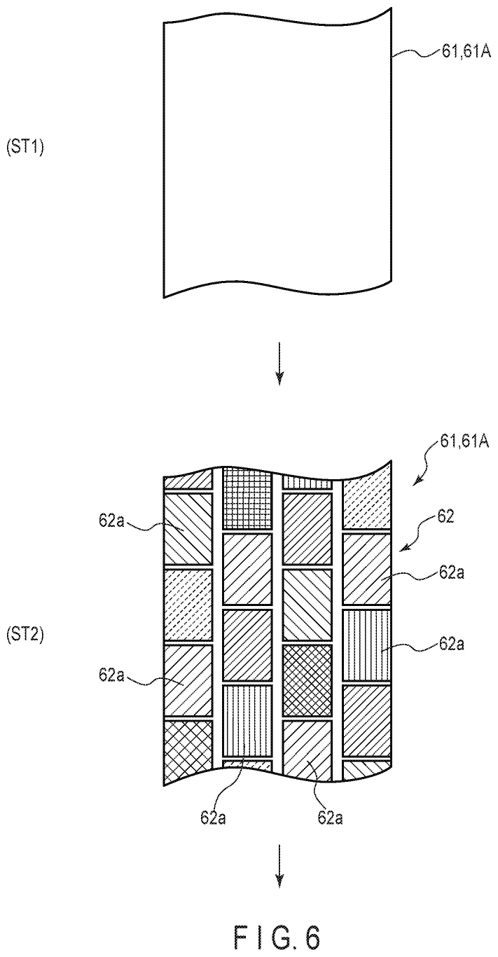

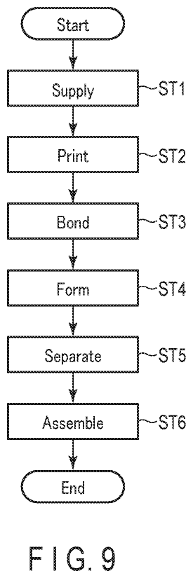

FIG. 1 is a plan view showing a configuration of the can lid 1 according to the embodiment of the present invention, and FIG. 2 is a cross-sectional view showing a configuration of the can lid 1. FIGS. 3 and 4 are plan views showing configurations of the tab 14, as viewed respectively from the upper side of the can lid 1 and from the side of a panel portion 11 of the can lid 1. FIG. 5 is a cross-sectional view showing a configuration of a part of the tab 14, that is, a configuration of members constituting the tab 14. FIGS. 6 to 8 are explanatory views showing examples of respective steps of the method for manufacturing the can lid 1, and FIG. 9 is a flowchart showing an example of the steps of the method for manufacturing the can lid 1.

As shown in FIG. 1, the can lid 1 is a so-called stay-on-tab (SOT) type can lid. The can lid 1 is a member of a can container in which, for example, a beverage such as a carbonated beverage or an alcoholic beverage is held as contents, and includes an opening portion for dispensing the contents from inside the can container to the outside. The can lid 1 is integrated with a can body of the can container by seaming.

The can container may be either a positive pressure can, the inside of which is under a positive pressure, or a negative pressure can, the inside of which is under a negative pressure, and may be either a two-piece can or a three-piece can. Also, the contents are not limited to beverages, and may be food products or may be something other than beverages and food products. That is, the contents considered applicable include a variety of things that can be sealed in a can container.

As shown in FIGS. 1 and 2, the can lid 1 includes a panel portion 11, a ring-shaped groove portion 12 provided on an outer peripheral edge of the panel portion 11, a flange portion 13 provided on an outer peripheral edge of the ring-shaped groove portion 12, and a tab 14 provided on the panel portion 11 and including a finger hook portion 33 which catches a user's finger. The can lid 1 is formed by pressing a metal plate to form the panel portion 11, the groove portion 12 and the flange portion 13 as a single unit, and then fixing the tab 14 formed in another process to the panel portion 11.

As shown in FIGS. 1 and 2, the panel portion 11 is formed in a disk shape. The panel portion 11 includes a rivet 21 and a score line 22 provided adjacent to the rivet 21. The panel portion 11 further includes, as appropriate, a concave portion provided on the outside of the score line 22 across the rivet 21 or on the periphery of the finger hook portion 33 of the tab 14, and a dome-shaped convex portion provided on a portion which is in contact with the tab 14.

The rivet 21 is provided on one main surface of the panel portion 11, and more specifically, on a main surface of the panel portion 11 which is located on an external side when the panel portion 11 is fixed to the can body of the can container. The rivet 21 is formed in a cylindrical shape substantially at the center of the panel portion 11 in such a manner as to project from one main surface of the panel portion 11. The rivet 21 is formed by drawing the center of the panel portion 11 into a cylindrical shape. By swaging the rivet 21 after the tab 14 is arranged, the tab 14 can be fixed to the panel portion 11.

By being broken, the score line 22 forms an opening piece 27 in the panel portion 11 for creating an opening of the can lid 1 in the panel portion 11. For example, in order to create an opening suitable for drinking of a beverage, the score line 22 is formed to have a substantially elliptical shape extending from the vicinity of the rivet 21 to the vicinity of the outer peripheral edge of the panel portion 11. The score line 22 constitutes a fragile part that enables a part of the panel portion 11 to be broken in the shape of the opening portion by an external force. The score line 22 is, for example, a groove provided on one main surface of the panel portion 11 in the shape of an outer periphery of the opening piece 27 such that the opening piece 27 is partially coupled to another portion of the panel portion 11. The score line 22 includes, for example, a main score line and a sub score line which is provided in parallel to the main score line and formed as a groove shallower than the main score line.

The groove portion 12 is a ring-shaped recess which is provided continuously with the outer peripheral edge of the panel portion 11 and projects to a can body side when the panel portion 11 is fixed to the can body.

The flange portion 13 is wound and fastened to an opening end of the can body. The flange portion 13 is provided with a sealing resin layer on a surface contacting the can body.

The tab 14 includes a fixing portion 31 which is fixed to the panel portion 11 with the rivet 21, a pressing portion 32 provided continuously with the fixing portion 31, and a finger hook portion 33 provided continuously with the pressing portion 32. In the tab 14, the pressing portion 32 and the finger hook portion 33 are formed integrally. The tab 14 is formed, for example, in an arcuate shape on the side of the pressing portion 32, and in a rectangular shape with arcuate corners on the side of the finger hook portion 33.

The tab 14 further includes a double or triple folded curl portion 14a on its outer peripheral edge. The curl portion 14a is disposed on a surface of the tab 14 which faces the panel portion 11 when the tab 14 is fixed to the panel portion 11.

The fixing portion 31 includes a rivet hole 31a into which the rivet 21 is inserted. The fixing portion 31 is located inward of the tab 14 and formed integrally with the pressing portion 32 in a flat plate shape. The pressing portion 32 presses a predetermined position in a region defined by the score line 22 when the tab 14 is operated. Here, the predetermined position in the region defined by the score line 22 is a position at which the pressing portion 32 can suitably apply an external force to the region defined by the score line 22 by operating the tab 14, and is appropriately set according to the shape of the score line 22, the shape of the tab 14, and the like.

The finger hook portion 33 includes a ring hole 33a, and further includes a double or triple folded curl portion 33b on an inner peripheral edge of the ring hole 33a. The curl portion 33b is disposed on the surface of the tab 14 which faces the panel portion 11 when the tab 14 is fixed to the panel portion 11. The distance between the tip of the finger hook portion 33 and the rivet hole 31a of the fixing portion 31 is longer than the distance between the rivet hole 31a of the fixing portion 31 and the tip of the pressing portion 32. The tip of the pressing portion 32 and the tip of the finger hook portion 33 constitute both longitudinal ends of the tab 14.

The finger hook portion 33 has a shape that can catch a finger at the time of the lid opening operation. For example, the curl portion 33b located at the end portion of the finger hook portion 33 is thinner than the curl portion 33b located at any other portion of the finger hook portion 33 and the curl portion 14a. Further, for example, the end portion of the finger hook portion 33 is separated from the main surface of the panel portion 11 in a state where the tab 14 is fixed to the panel portion 11. Furthermore, in order to easily catch a finger at the time of the lid opening operation, for example, the finger hook portion 33 is arranged such that its tip faces the concave portion provided on the panel portion 11.

The tab 14 as described above is formed by pressing and curling a laminated metal plate 50. As shown in FIG. 5, the laminated metal plate 50 is formed by laminating a resin film 52 on a coil-shaped base member 51 made of an aluminum alloy, a surface-treated steel plate, or the like. As a specific example, the laminated metal plate 50 includes a base member 51 called a so-called tab coil and a resin film 52 laminated on the outer surface of the base member 51.

As the base member 51, for example, a tab coil made of an aluminum alloy is used. Also, as the base member 51, for example, a tab coil in which a coil coating is applied to one of the main surfaces and no coating is applied to the other main surface and which has a thickness of 0.27 mm and a width of 520 mm is used.

The resin film 52 includes a film layer 61, a printing layer 62 printed on one of the main surfaces of the film layer 61, and a bonding layer 63 which is provided on that main surface of the film layer 61 and covers the printing layer 62.

Suitable materials used for the film layer 61 include a polyester-based resin film such as polyethylene terephthalate or polybutylene terephthalate, an olefin-based resin film such as polyethylene or polypropylene, and a polyamide-based resin film such as nylon 6 or nylon 6,6. As the film layer 61, an original film 61A made of a suitable material is used.

The printing layer 62 is formed by performing gravure painting on the film layer 61. For example, as shown in FIG. 5, the printing layer 62 is printed on a position of the film layer 61 which faces an area of the laminated metal plate 50 where the tab 14 is formed. The printing layer 62 includes, for example, a plurality of rectangular printing portions 62a arranged in an area of the film layer 61 where the tab 14 is formed. Each of the printing portions 62a is printed, for example, in a single color or in a plurality of colors. As a specific example, each printing portion 62a is printed with a single color paint containing a pigment, and for the plurality of printing portions 62a, paints of a plurality of colors are used. The plurality of printing portions 62a are randomly arranged at predetermined positions of the film layer 61. As a paint used in the present embodiment, gravure printing ink can be suitably used.

Next, a method for manufacturing the can lid 1 including the tab 14 configured as described above will be described with reference to FIGS. 6 to 9.

First, an original film 61A (film layer 61) is set in a gravure printer and supplied to a gravure plate (step ST1), and then a plurality of printing portions 62a are printed on a back surface of the original film 61A with the gravure plate (step ST2). Specifically, the gravure printer has gravure plates corresponding to types of paint used for printing, and in such a gravure printer, the original film 61A is sequentially supplied to those gravure plates, and the printing portions 62a are sequentially printed in respective colors on the original film 61A.

Then, an adhesive is applied to the back surface of the original film 61A (film layer 61) on which the printing layer 62 is provided, to form a bonding layer 63, thereby forming the resin film 52. Then, the resin film 52 is bonded to the base member 51 (step ST3). As a result, the laminated metal plate 50 in which the resin film 52 is laminated on the base member 51 is formed.

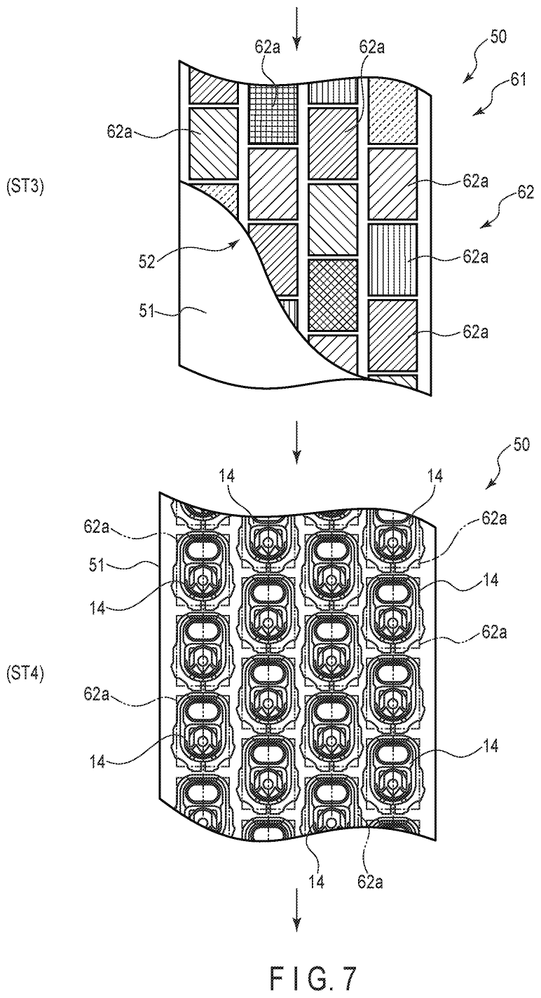

Then, the tab 14 is formed by processing such as pressing and rolling, such that the other main surface of the laminated metal plate 50 becomes an external main surface of the tab 14, in other words, such that the film layer 61 is disposed in the external main surface of the tab 14 (step ST4). Here, the external main surface of the tab 14 is a surface exposed to the outside when the tab 14 is fixed to the panel portion 11. Further, as shown in FIG. 7, the tab 14 is formed with a part thereof connected to the laminated metal plate 50, and thus held by the laminated metal plate 50. In the tab 14 formed as described above, the film layer 61 lies on the entire external surface of the tab 14 and on the surfaces of the curl portions 14a and 33b.

Then, a portion where the tab 14 and the laminated metal plate 50 are connected is broken to separate the formed tab 14 from the laminated metal plate 50 (step ST5). Then, the tab 14 is assembled to the panel portion 11 (step ST6). As a specific example, the rivet 21 is inserted into the rivet hole 31a of the tab 14, and the tab 14 is arranged on the panel portion 11 such that the tip of the pressing portion 32 is located at the predetermined position in the region defined by the score line 22 and the finger hook portion 33 is located at a position opposite to the score line 22 with respect to the rivet 21. Then, a portion of the rivet 21 projecting from the fixing portion 31 is swaged into a flat plate shape to fix the tab 14 to the panel portion 11.

In the panel portion 11 including the tab 14 formed as described above, a deformed portion 21a of the rivet 21 is in contact with the film layer 61 present on the surface of the fixing portion 31 of the tab 14. Further, a part of the external surface of the panel portion 11 is in contact with at least a part of the curl portions 14a and 33b of the tab 14. With this configuration, even when the tab 14 is movable in a rotational direction about the rivet 21, the tab 14 is partially kept in intimate contact with the panel portion 11 because, for example, the film layer 61 of the tab 14 and a part of the panel portion 11 are in contact with each other, and thereby the film layer 61 is pressed by that part of the panel portion 11.

Therefore, the can lid 1 can prevent the tab 14 from moving in the rotational direction about the rivet 21. As a result, in the can lid 1, since the rotation of the tab 14 about the rivet 21 is prevented, and the positional relationship between the score line 22 and the tab 14 when the tab 14 is assembled to the panel portion 11 is maintained, the force of leverage generated by the tab 14 at the time of the lid opening operation can be sufficiently applied to the score line 22. In addition, since the film layer 61 is present in the external surface of the tab 14, the main surface of the base member 51 on which the resin film 52 is provided is protected by the resin film 52, and thus corrosion of the main surface of the base member 51 on which the resin film 52 is provided can be prevented. Thus, since the main surface of the base member 51 on which the resin film 52 is provided need not be subjected to surface treatment, and as a result, manufacturing costs of the laminated metal plate 50 required for surface treatment can be reduced.

In this manner, in the can lid 1, by forming the tab 14 from the laminated metal plate 50 on which the film layer 61 is provided on its one of the main surfaces, easy lid openability (i.e., the ease of breaking the score line 22 by the tab 14) can be maintained.

Further, in the can lid 1, the tab 14 is formed by pressing the laminated metal plate 50 instead of laminating a film layer on the formed tab. By doing so, the film layer 61 is removed when the rivet hole 31a is formed, and thus the film layer 61 is not present on the inner peripheral surface of the rivet hole 31a. That is, by forming the tab 14 from the laminated metal plate 50, the film layer 61 does not hinder the ease of assembly when the tab 14 is assembled to the panel portion 11. In addition, since conventionally used apparatuses can be used as a manufacturing apparatus of the tab 14 and an assembling apparatus of the can lid 1, the equipment cost is not increased.

Furthermore, since the laminated metal plate 50 includes the printing layer 62, the decorativeness of the tab 14 can be improved. In addition, the printing layer 62 is disposed between the base member 51 and the film layer 61. Thus, in forming the tab 14 from the laminated metal plate 50, even when the laminated metal plate 50 is formed in a direction in which the surface of the base member 51 on which the film layer 61 is provided extends, the printing layer 62 is protected by the film layer 61. As a result, the printing layer 62 is prevented from peeling off and also prevented as much as possible from becoming thin, and thereby the printing layer 62 can maintain its preferable color. Therefore, the decorativeness of the tab 14 is not decreased. In addition, it is possible to prevent the paint constituting the printing layer 62 from peeling off and adhering to the surface of the tab 14 or adhering to a forming mold. In addition, since peeling paint can be prevented from adhering to the mold, wear on the mold by the pigment in the paint can also be prevented.

Furthermore, by randomly arranging on the film layer 61 the plurality of printing portions 62a of the printing layer 62 in a plurality of colors by gravure printing, a plurality of tabs 14 as formed have random colors. By assembling such tabs 14 to the panel portions 11, the tabs 14 of produced can lids 1 have random colors. Thus, when a plurality of can containers are manufactured by using the produced can lids 1, the colors of the tabs 14 of those produced can containers can be made random. Therefore, by using such can lids 1 for can containers, a plurality of can containers having the tabs 14 whose colors are random are arranged on a display shelf or the like of a store at the time of sale, and thus the decorativeness of the can containers, at the time of sale, can be improved.

As described above, the can lid 1 including the tab 14 according to the embodiment of the present invention can prevent the rotation of the tab 14 in the circumferential direction with a simple configuration by forming the tab 14 from the laminated metal plate 50.

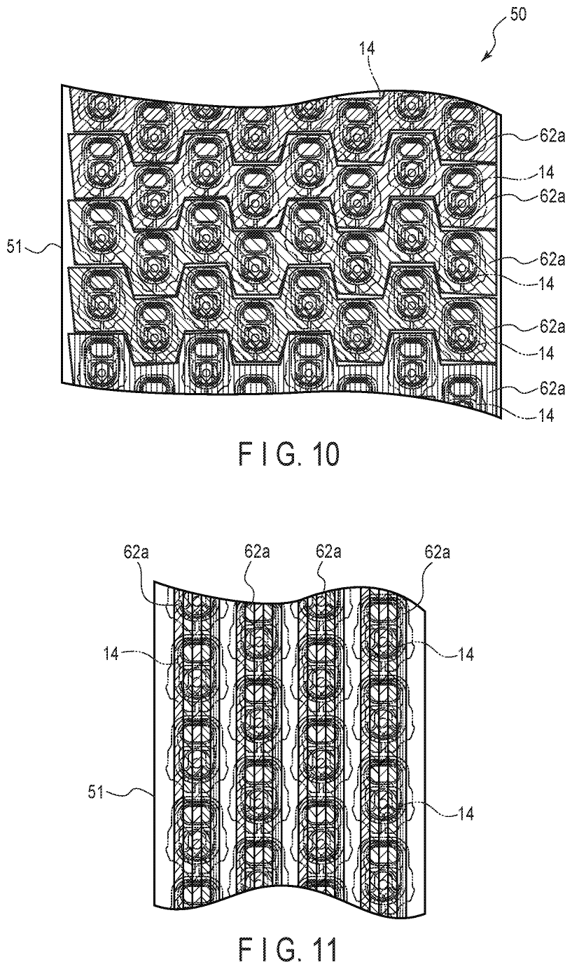

The present invention is not limited to the above embodiment. For example, the print pattern of the printing portions 62a of the printing layer 62 is not limited to the above-described random arrangement. For example, as shown in FIG. 10, a plurality of tabs arranged in the horizontal direction can be regarded as one printing portion 62a and printed in a single color or in a plurality of colors. Also, as shown in FIG. 11, a plurality of tabs arranged in the vertical direction can be regarded as one printing portion 62a and printed in a single color or in a plurality of colors.

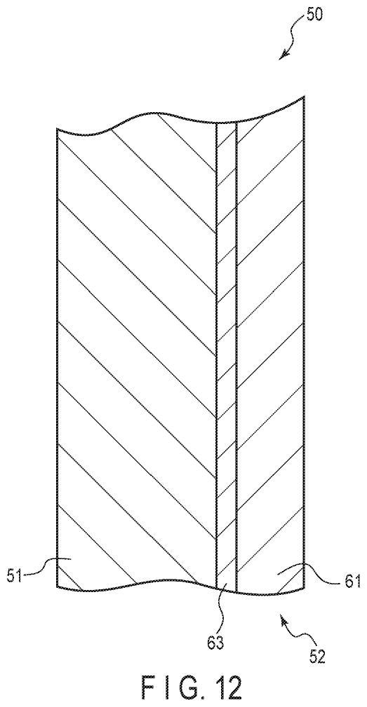

Further, for example, as shown in FIG. 12, the laminated metal plate 50 may be configured not to include the printing layer 62. That is, as long as the laminated metal plate 50 is configured to include the film layer 61, the rotation of the tab 14 can be prevented. In addition, the printing layer 62 is preferably formed by gravure printing, but the printing method is not limited to gravure printing and may be other printing methods. In addition, when the laminated metal plate 50 does not include the printing layer 62, the film layer 61 may be colored.

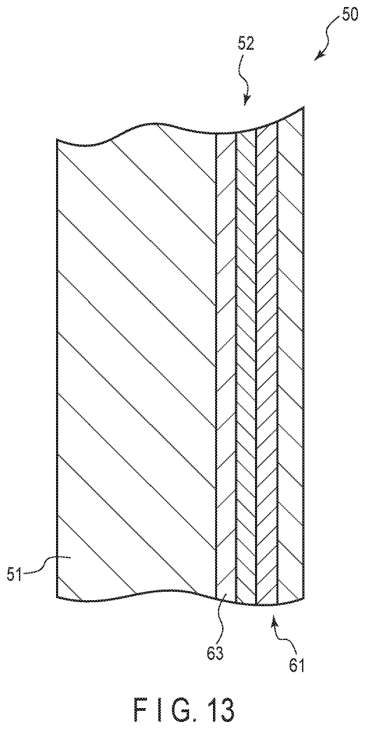

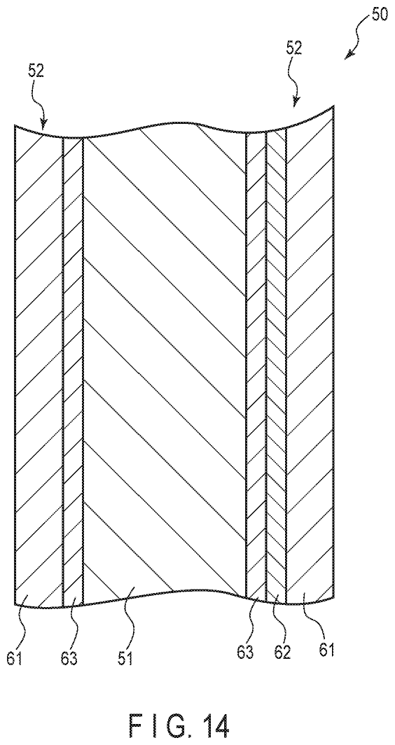

Furthermore, for example, as shown in FIG. 13, the film layer 61 may have a multilayer structure in which one of a plurality of layers is a colored film layer. In addition, for example, as shown in FIG. 14, the film layer 61 may be bonded to both of the main surfaces of the laminated metal plate 50. In addition, the tab 14 may be of a so-called universal design by using a high-visibility paint for printing of the printing layer 62 to make the tab 14 easily distinguishable.

That is, the present invention is not limited to the above-described embodiments, and can be modified in practice without departing from the spirit of the invention. The embodiments may also be implemented by combining them appropriately, in which case the combined advantages are obtained. Furthermore, the embodiments include various inventions, and such various inventions can be derived by properly combining the structural elements disclosed in connection with the embodiments. For example, even if some structural elements are deleted from all the structural elements shown in the embodiments, when the problem can be solved and the advantageous effects can be obtained, such a configuration in which those structural elements are deleted can be extracted as an invention.

What is claimed is:

1. A tab formed of a metal plate in which a resin film is laminated on at least one main surface of a base member made of a metal material, comprising: a fixing portion including a rivet hole into which a rivet formed on a panel portion of a can lid is inserted;
a pressing portion formed integrally with the fixing portion and configured to press a portion in a region defined by a score line formed on the panel portion; and
a finger hook portion formed integrally with the pressing portion.

2. The tab according to claim 1, wherein the metal plate includes a printing layer on a surface of the resin film which faces the base member.

3. The tab according to claim 2, wherein the printing layer is provided by gravure printing.

4. The tab according to claim 1, wherein the resin film is colored or has a multilayer structure including a colored layer.

5. The tab according to claim 1, wherein the finger hook portion includes a ring hole, and
the tab further comprises double or triple folded curl portions provided on an outer peripheral edge of the pressing portion and the finger hook portion and on an inner peripheral edge of the ring hole.

6. A can lid comprising: a panel portion including a rivet and a score line which is provided adjacent to the rivet and broken by application of an external force to form an opening piece; and
a tab which is formed of a metal plate in which a resin film is laminated on one at least one main surface of the base member made of a metal material, and which includes a fixing portion including a rivet hole into which the rivet is inserted, a pressing portion which is formed integrally with the fixing portion and configured to press a portion in a region defined by the score line, and a finger hook portion which is formed integrally with the pressing portion.

7. The can lid according to claim 6, wherein the metal plate includes a printing layer on a surface of the resin film which faces the base member.

8. The can lid according to claim 7, wherein the printing layer is provided by gravure printing.

9. The can lid according to claim 6, wherein the resin film is colored or has a multilayer structure including a colored layer.

10. The can lid according to claim 6, wherein the finger hook portion includes a ring hole, and
the can lid further comprises a curled portion which is doubly or triply folded and is provided on an outer periphery of the pressing portion and the finger hook portion and on an inner periphery of the ring hole.

11. A method for manufacturing a can lid, comprising: forming a metal plate by bonding a film layer to at least one main surface of a thin plate-shaped base member made of a metal material;
forming a tab from the metal plate such that a main surface of the metal plate on which the film layer is provided becomes an external main surface of the tab when the tab is fixed to a panel portion of a can lid, wherein the tab includes a fixing portion including a rivet hole into which a rivet formed in the panel portion is inserted, a pressing portion formed integrally with the fixing portion and configured to press a portion in a region defined by a score line formed in the panel portion, and a finger hook portion formed integrally with the pressing portion; and
arranging the formed tab on the panel portion and swaging the rivet inserted into the rivet hole.

12. The method for manufacturing the can lid according to claim 11, wherein a printing layer is printed on a surface of the film layer which faces the base member before the film layer is bonded to the at least one main surface of the base member.

13. The method for manufacturing the can lid according to claim 12, wherein the printing layer is printed by gravure printing.
